(19) United States
(12) Patent Application Publication
(10) Pub. No.: US 2008/0284182 A1
(43) Pub. Date: Nov. 20, 2008

(54) Door Jamb Enforcer

(76) Inventor: Aubrey L. Canerdy, JR., Arlington, TN (US)

Correspondence Address: David J. Kreher;Attorney at Law, 2099 Hampton Hill Drive, Memphis, TN, 38134, US

(21) Appl. No.: 11/803,301

(22) Filed: May 14, 2007

(51) Int. Cl. E05B 17/20

(52) U.S. Cl. 292/346; 49/504

(57) ABSTRACT

A doorjamb attachment for reinforcing door jambs to prevent forced entry through the doorway by strengthening the composite materials of the door jamb. The device is made of 14 gauge ASTM, A-36, Mild Steel with holes through which the latching and locking mechanisms of the door may pass, as well as smaller beveled holes to pass screws through to attach the device to the doorframe. The device is also formed so as to facilitate latching mechanism closure. This device can also be used to assist in the repair of damaged door jambs by holding together the damaged portions once they are placed back in position.

### FIELD OF THE INVENTION

This invention relates to the reinforcement of doorways to prevent damage to and forced entry through the doorway, while facilitating the manual movement of the closure. The device is inserted in the doorway door jamb and possesses the means particularly adapted for cooperation with opening or closing movement of a door latching mechanism. The nature of the device allows for the latching and locking mechanisms to pass through the device and assist in restraining the latching and locking mechanism in the event that the bolt is forced back by extraneous means, while preventing damage to the closure. The device can also be sued to repair damaged door jambs by holding the damaged parts together while strengthening the damaged region.

The door jamb attachment specifically addresses deficiencies of prior art in the area by facilitating the latching mechanism of the door, allowing for easy installation, and not requiring disassembly of the decorative molding or destruction of existing wall structure.

### BACKGROUND OF THE INVENTION

The door jamb attachment was developed to counteract the growing threat of break-ins made easier by the abundant use of pre-hung entry doors with wooden jambs. Many of the jambs are built from finger-jointed wood which is not sturdy enough to withstand a forced entry blow, especially to the area in and around the latching and locking mechanism.

Several attempts have been made to develop a reinforcing mechanism for door jambs but all involve either the attachment of multiple pieces to the door jamb, the interference with the easy operation of the door's latching and locking mechanisms, or the disassembly and reassembly of the decorative molding and/or wallboard for proper installation.

In U.S. Pat. App. 20030159361, Yeremian discloses a reinforced doorjamb where two plates are used to reinforce the door. However, installation of the plates involves cutting open the wallboard to expose the interior side of the door jamb. The decorative molding and wallboard must be removed in order to attach the plates for reinforcing the door latch and bolt.

In U.S. Pat. App. 20030062731, Richmond et al. discloses an L-shaped elongated piece of steel which is secured to the door jamb area by removing the decorative molding and attaching tabs which comprise one part of the L-shaped elongated piece to the wall. The other portion of the L-shaped elongated piece protects the door jamb area that receives the latching and locking bolts.

In U.S. Pat. No. 5,070,650, Anderson discloses two elongated metal plates, the first to be mounted to the door jamb latch and lock bolt receiving portion, while the second plate overlays the first plate and is also attached to the area beneath the decorative molding.

In U.S. Pat. No. 5,566,509, Long discloses an elongated L-shaped piece of steel which is attached to the door jamb latch and lock bolt receiving portion of the door jamb, where the L-shaped portion is bent around the edge of the door jamb toward but not underneath the decorative molding. With this disclosure, and other L-shaped disclosures, the door is prevented from closing properly because the latching mechanism is not fed into the latch receiving portion of the door jamb as the door approaches the door jamb but instead rams against the L-shaped portion.

### SUMMARY OF THE INVENTION

A door jamb enforcer for reinforcing door jambs to prevent forced entry through the doorway by strengthening the composite materials of the door jamb. The device is made of 14 gauge ASTM, A-36, Mild Steel with holes through which the latching and locking mechanisms of the door may pass, as well as smaller beveled holes into which screws attach the device to the door jamb. Further, the device is also formed so as to facilitate door latching mechanism closure. This device can also be used to assist in the repair of damaged door jambs by securing the damaged portions once they are placed back in position.

### BRIEF DESCRIPTION OF THE SEVERAL VIEWS OF THE DRAWING

FIG. 1 is a front elevational view of the reinforcement strip of this invention, displaying the preferred embodiment of the larger, latching and locking mechanism holes as well as the locations of the smaller, beveled edge holes used to attach the device to the door jamb;

FIG. 2 is an end elevational view of this invention, displaying the preferred embodiment of the angle of the formed edge relative to the rest of the reinforcement strip;

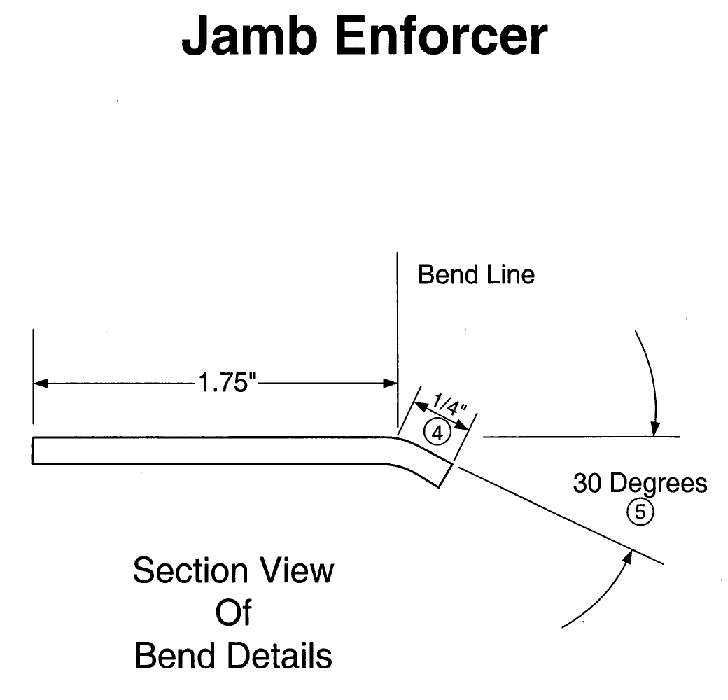

FIG. 3 is an enlargement of one of the smaller holes, displaying the beveled nature of each; and

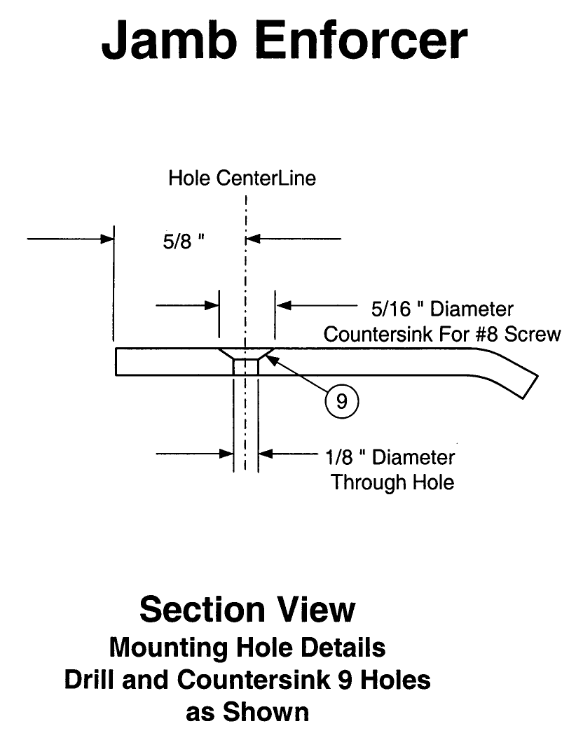

FIG. 4 is a perspective cut-away view of the reinforcement strip of the present invention located on a door jamb which shows the relationship of the reinforcement strip with the door jamb and associated wall studs.

FIG. 5. is a perspective cut-away view of the reinforcement strip as installed on a door jamb which shows the relationship of the reinforcement strip with the exterior wood jamb and interior trim.

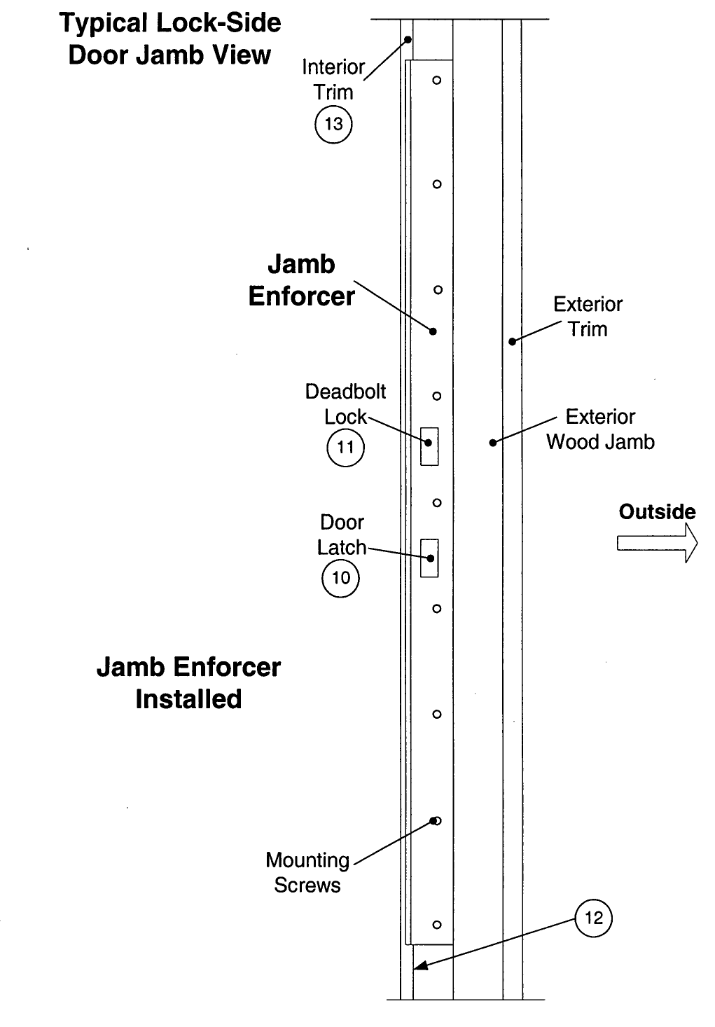

### DETAILED DESCRIPTION OF THE INVENTION

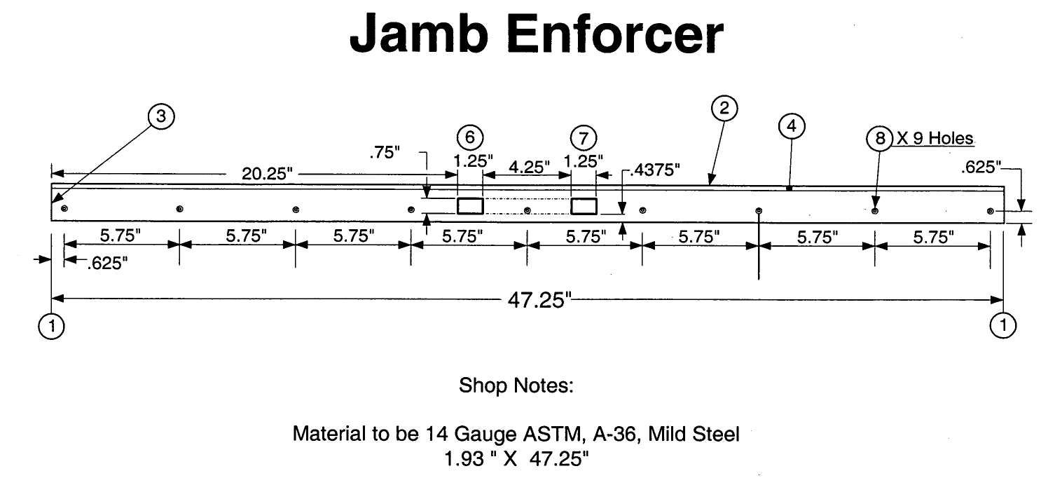

A door jamb enforcer to prevent forced entry comprising: a single piece of resistant material, front face, back, a formed edge that bends in from the plane of the rest of the face, holes to allow the attachment of the door jamb enforcer to a door jamb, and holes to allow the latching and locking mechanisms to pass through. The preferred embodiment of the door jamb enforcer, as detailed in FIG. 1, comprises a single piece of 14-gauge ASTM, A-36, Mild Steel, with a length edges 1 and 2 equal to 47.25 inches and a width equal to 1.93 inches 3. A formed portion 4 is angled out of the plane of the rest of the front face at an angle 5 of 30° and located 0.25 inches in from length edges 1 and 2. There are two holes 6 and 7 of a size appropriate through which a latch or locking bolt is allowed to pass. Holes 6, 7 are spaced equal distance from the center of the entire length of the doorjamb enforcer such that the holes match with the latching or locking mechanism. The door jamb enforcer's composition material is maximized between the length opposite the inner length edge 1 of the formed portion 4, the holes 6, 7, and the form 4, to maximize the material on either side of holes 6, 7. There are also nine smaller fastening holes 8, with the hole centered between the length opposite the form 2 and form 4. Fastening holes 8 being large enough to allow the threaded portion a threaded fastener to pass through and having a beveled edge 9 on the front face of the door jamb enforcer to allow the top of the threaded fastener head to rest flush with the door jamb enforcer when the threaded portion has passed through fastening holes 8. Fastening holes 8 nearest to the ends of length edges 1, 2 are located 0.625 inches from the end to the edge of the fastening holes. The remaining fastening holes 8 are spaced equally along the remaining length.

The door jamb enforcer is made by form pressing a piece of 14-gauge ASTM, A-36, Mild Steel of the appropriate length to shape it and create holes 6, 7 and fastening holes 8 as detailed in the preferred embodiment. Then, the door jamb enforcer is either coated with a desired color using powder-based paint or left uncoated.

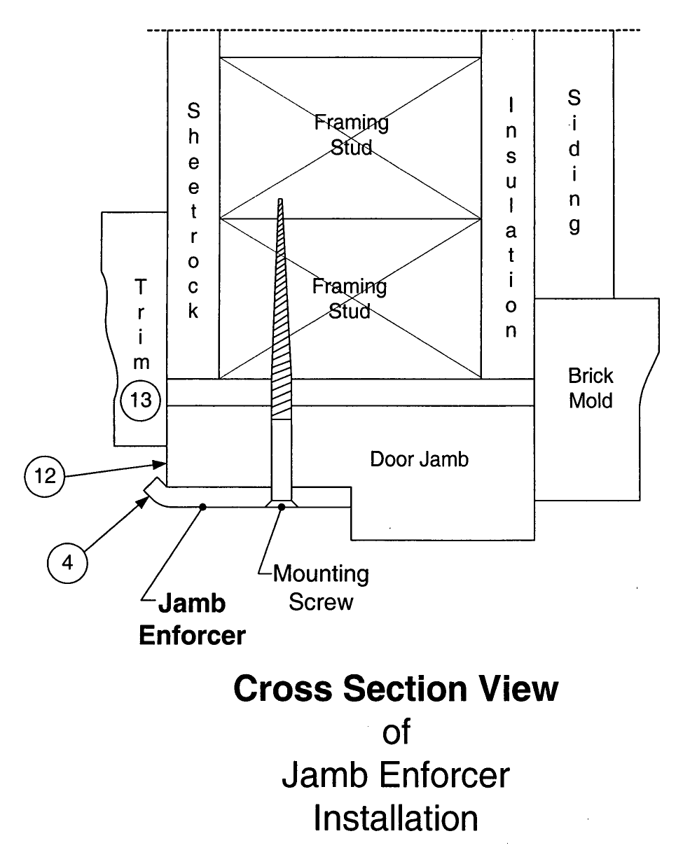

The door jamb enforcer is attached to a door jamb along the latching or locking mechanism receiving side of the door jamb using threaded fasteners, typically 3 inch #8 screws (See FIG. 4). The mounting of the door jamb enforcer to the door jamb is accomplished by first aligning the latching 10 and locking 11 holes in the door jamb with holes 6, 7 in the door jamb enforcer, where the formed portion of the door jamb enforcer is aligned with the outer edge 12 of the door jamb, to angle away from the door opening toward the decorative molding. The formed portion 4 does not interfere with the decorative molding 13. Next, mark the locations of the fastening holes 8. The door jamb enforcer is then removed and the fastening holes 8 are pre-drilled to prevent the door jamb and wall studs from splitting. Once the fastening holes 8 are predrilled, the door jamb enforcer is again placed against the door jamb, aligning holes 6, 7 with latching 10 and locking 11 holes and the predrilled holes in the door jamb with fastening holes 8. Threaded fasteners are then hand tightened through fastening holes 8 in the door jamb enforcer into the door jamb and wall studs. If the door does not completely close after installation, hand tighten the threaded fasteners further, to allow the wood of the door jamb to be compressed which will make additional space to allow for door closure.

What is claimed:

1. An apparatus to prevent forced entry comprising: a single formed plate with a front face, back, length edges, a formed portion along the length of the door jamb enforcer, a hole to allow the latching and locking mechanism to pass through, and a plurality of fastening holes to allow the attachment of the door jamb enforcer to the latching and locking mechanism receiving side of the door jamb with threaded fasteners long enough to penetrate through the door jamb into the wall stud;
said formed portion is located between 0.1 inches and 1 inch from a length edge and is angled away from the plane of the front face at an angle of between 5° and 85°, which does not interfere with the decorative molding, and so as not to make an L-shaped portion;
and whereby said hole to allow the latching and locking mechanism to pass through is located at the center of the length of the door jamb enforcer and spaced sufficiently from the length edge opposite of the interior portion of the formed portion and the interior portion of the formed portion to match the location of the latching or locking mechanism, with as much attachment material as possible on either side of the hole;
and whereby said plurality of fastening holes are centered between the length opposite the interior edge of the formed portion and the interior edge of the formed portion, wherein the front face edge of the fastening hole is beveled to allow the top of the threaded fastener head to be flush with the door jamb enforcer when the threaded portion has passed through the hole; and where the fastening holes nearest the ends of the door jamb enforcer length are at least 0.1 inches from the ends, preferably 0.625 inches, while the remaining fastening holes are spaced equally along the remaining length.

2. The door jamb enforcer of claim 1 wherein the attachment is a single piece, made up of a resistant material such as wood, iron, steel, aluminum, copper, brass, silicon, or plastic.

3. The door jamb enforcer of claim 2 wherein the thickness of the material is between 0.05 inches and 0.5 inches.

4. The door jamb enforcer of claim 3 wherein the length of the attachment is between 6 inches and 90 inches.

5. The doorjamb enforcer of claim 4 wherein the width of the attachment is between 0.5 inches and 3 inches.

6. The door jamb enforcer of claim 1, whereby, there are two holes to allow a latching and locking mechanism to pass through.

7. The door jamb enforcer of claim 6 wherein the attachment is a single piece, made up of a resistant material such as wood, iron, steel, aluminum, copper, brass, silicon, or plastic.

8. The door jamb enforcer of claim 7 wherein the thickness of the material is between 0.05 inches and 0.5 inches.

9. The door jamb enforcer of claim 8 wherein the length of the attachment is between 6 inches and 90 inches.

10. The door jamb enforcer of claim 9 wherein the width of the attachment is between 0.5 inches and 3 inches.

11. The door jamb enforcer of claim 1 wherein the door jamb enforcer is attached to a door jamb along the side of the door jamb that receives the latching or locking mechanism, with the length edge opposite the interior edge of the formed portion to align with the inside edge of the door jamb stop, the formed portion edge to match along the outside of the door jamb and the formed portion edge to angle away from the doorway.
